(19) United States
(12) Patent Application Publication
(10) Pub. No.: US 2019/0266158 A1
(43) Pub. Date: Aug. 29, 2019

(54) SYSTEM AND METHOD FOR OPTIMIZING SEARCH QUERY TO RETREIVE SET OF DOCUMENTS

(71) Applicant: Innoplexus AG, Eschborn (DE)

(72) Inventors: Abhilash Bolla, Vadodara (IN); Rohit Anurag, Bokaro (IN); Vatsal Agarwal, Rampur (IN)

(21) Appl. No.: 16/146,436

(22) Filed: Sep. 28, 2018

(30) Foreign Application Priority Data
Feb. 27, 2018 (IN) 201821007322P

(51) Int. Cl. G06F 16/2453; G06F 16/93; G06F 16/22

(52) U.S. Cl. CPC G06F 16/24535; G06F 16/22; G06F 16/24542; G06F 16/93

(57) ABSTRACT

Disclosed is system for optimizing search query to retrieve set of documents, system comprising client device configured to receive search query and provide set of documents; lexical database comprising plurality of concepts, and conceptual synonyms of plurality of concepts; structured database communicably coupled to lexical database, wherein structured database is developed by: extracting plurality of documents; analyzing plurality of documents to determine concept corresponding to plurality of documents; and indexing plurality of documents, wherein given document is indexed based on concept corresponding to given document, and conceptual synonyms of concept; and server arrangement communicably coupled to client device, lexical database and structured database, wherein server arrangement is configured to: receive search query, from client device; segment search query into query segments; analyze query segments to determine concepts; identify, conceptual synonyms of concepts; and retrieve set of documents based on concepts corresponding to query segments and conceptual synonyms of concepts.

### CROSS-REFERENCE TO RELATED APPLICATIONS

This is a non-provisional patent application based upon an Indian provisional patent application no. IN201821007322P as filed on Feb. 27, 2018, and claims priority under 35 U.S.C. 199(e).

### TECHNICAL FIELD

The present disclosure relates generally to searching techniques and specifically to, systems for optimizing search query to retrieve set of documents. Moreover, the present disclosure relates to methods of optimizing search query to retrieve a set of documents.

### BACKGROUND

With development in technology and networking, a large amount of information is generated by individuals and/or organizations. The information is stored in form of documents. The individuals and/or organizations regularly need to retrieve the stored information for their use and development. The retrieval of information is done by searching via entering query for the information present in the documents, mapping the entered query with the information in different documents, and producing the mapped information to the individual and/or organizations.

Generally, the individuals and/or organizations search by entering only the search query related to the information which is required for their use and development. As a result, only the documents having the keyword from entered query are retrieved. Furthermore, the documents having synonyms of the entered query are not retrieved. The information in the documents having synonyms of the entered query is essential to the individual and/or organizations searching for the information. In an example, an individual searching for lung cancer will only be retrieved with the documents which have the word lung cancer present in them. The documents which have the word similar in meaning to lung cancer such as lung carcinoma will not be retrieved to the individual and/or organizations searching for the information related to lung cancer. Additionally, the information retrieved is of different field/subject area compared to the field/subject area of the entered query. The mismatch of the field/subject area results in retrieval of irrelevant documents.

Generally, the individuals and/or organizations need only specific information from the documents comprising a large amount of information. However, the information produced after retrieval from documents to the individuals and/or organizations comprises a lot of irrelevant information along with the specific information. The individual and/or organization have to put additional efforts and resources to filter the specific information from the retrieved information in the documents.

Therefore, in light of the foregoing discussion, there exists a need to overcome the aforementioned drawbacks associated with existing searching techniques.

### SUMMARY

The present disclosure seeks to provide a system for optimizing a search query to retrieve a set of documents. The present disclosure also seeks to provide a method of optimizing a search query to retrieve a set of documents. The present disclosure seeks to provide a solution to the existing problem of incomplete results retrieved by existing searching techniques. An aim of the present disclosure is to provide a solution that overcomes at least partially the problems encountered in prior art, and provides a complete and all-inclusive set of documents for a search query.

In one aspect, an embodiment of the present disclosure provides a system for optimizing a search query to retrieve a set of documents, the system comprising:

a client device configured to receive the search query and provide the set of documents;

a lexical database comprising a plurality of concepts, and conceptual synonyms of each of the plurality of concepts;

a structured database communicably coupled to the lexical database, wherein the structured database is developed by:
extracting a plurality of documents from existing data sources;
analyzing each of the plurality of documents to determine at least one concept corresponding to each of the plurality of documents; and
indexing the plurality of documents using the lexical database, wherein a given document is indexed based on the at least one concept corresponding to the given document, and conceptual synonyms of the at least one concept corresponding to the given document; and

a server arrangement communicably coupled to the client device, the lexical database and the structured database, wherein the server arrangement is configured to:
receive the search query, from the client device;
segment the search query into one or more query segments;
analyze the one or more query segments to determine one or more concepts corresponding to the one or more query segments;
identify, using the lexical database, conceptual synonyms of each of the one or more concepts corresponding to the one or more query segments; and
retrieve the set of documents from the structured database based on the one or more concepts corresponding to the one or more query segments and conceptual synonyms of each of the one or more concepts corresponding to the one or more query segments.

In another aspect, an embodiment of the present disclosure provides a method of optimizing a search query to retrieve a set of documents, the method is implemented via a system comprising:

a client device configured to receive the search query and provide the set of documents;

a lexical database comprising a plurality of concepts, and conceptual synonyms of each of the plurality of concepts;

a structured database communicably coupled to the lexical database, wherein the structured database is developed by:
extracting a plurality of documents from existing data sources;
analyzing each of the plurality of documents to determine at least one concept corresponding to each of the plurality of documents; and
indexing the plurality of documents using the lexical database, wherein a given document is indexed based on the at least one concept corresponding to the given document, and conceptual synonyms of the at least one concept corresponding to the given document; and

a server arrangement communicably coupled to the client device, the lexical database and the structured database, wherein the method comprises:
receiving the search query, from the client device;
segmenting the search query into one or more query segments;
analyzing the one or more query segments to determine one or more concepts corresponding to the one or more query segments;
identifying, using the lexical database, conceptual synonyms of each of the one or more concepts corresponding to the one or more query segments; and
retrieving the set of documents from the structured database based on the one or more concepts corresponding to the one or more query segments and conceptual synonyms of each of the one or more concepts corresponding to the one or more query segments.

Embodiments of the present disclosure substantially eliminate or at least partially address the aforementioned problems in the prior art, and enables retrieval of documents comprising information related to entered query as well as synonyms of the entered query.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a network environment of a system for optimizing a search query to retrieve a set of documents, in accordance with an embodiment of the present disclosure; and

FIG. 2 illustrate steps of a method of optimizing a search query to retrieve a set of documents, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a system for optimizing a search query to retrieve a set of documents, the system comprising:

a client device configured to receive the search query and provide the set of documents;

a lexical database comprising a plurality of concepts, and conceptual synonyms of each of the plurality of concepts;

a structured database communicably coupled to the lexical database, wherein the structured database is developed by:
extracting a plurality of documents from existing data sources;
analyzing each of the plurality of documents to determine at least one concept corresponding to each of the plurality of documents; and
indexing the plurality of documents using the lexical database, wherein a given document is indexed based on the at least one concept corresponding to the given document, and conceptual synonyms of the at least one concept corresponding to the given document; and

a server arrangement communicably coupled to the client device, the lexical database and the structured database, wherein the server arrangement is configured to:
receive the search query, from the client device;
segment the search query into one or more query segments;
analyze the one or more query segments to determine one or more concepts corresponding to the one or more query segments;
identify, using the lexical database, conceptual synonyms of each of the one or more concepts corresponding to the one or more query segments; and
retrieve the set of documents from the structured database based on the one or more concepts corresponding to the one or more query segments and conceptual synonyms of each of the one or more concepts corresponding to the one or more query segments.

In another aspect, an embodiment of the present disclosure provides a method of optimizing a search query to retrieve a set of documents, the method is implemented via a system comprising:

a client device configured to receive the search query and provide the set of documents;

a lexical database comprising a plurality of concepts, and conceptual synonyms of each of the plurality of concepts;

a structured database communicably coupled to the lexical database, wherein the structured database is developed by:
extracting a plurality of documents from existing data sources;
analyzing each of the plurality of documents to determine at least one concept corresponding to each of the plurality of documents; and
indexing the plurality of documents using the lexical database, wherein a given document is indexed based on the at least one concept corresponding to the given document, and conceptual synonyms of the at least one concept corresponding to the given document; and

a server arrangement communicably coupled to the client device, the lexical database and the structured database, wherein the method comprises:
receiving the search query, from the client device;
segmenting the search query into one or more query segments;
analyzing the one or more query segments to determine one or more concepts corresponding to the one or more query segments;
identifying, using the lexical database, conceptual synonyms of each of the one or more concepts corresponding to the one or more query segments; and
retrieving the set of documents from the structured database based on the one or more concepts corresponding to the one or more query segments and conceptual synonyms of each of the one or more concepts corresponding to the one or more query segments.

The present disclosure provides the aforementioned system and the aforementioned method for optimizing a search query to retrieve a set of documents. Beneficially, the system provides retrieved documents comprising information related to entered search query as well as synonyms of the entered search query. Consequently, the user is provided with a complete and all-inclusive set of documents related to the search query.

The system is configured to optimize the search query to retrieve the set of documents. The system refers to a collection of one or more programmable and non-programmable components that are operable to aggregate the set of documents and further retrieve the set of documents based on the search query. In an example, the system comprises aggregating the set of documents related to research in life science which are essential for future use and development, and retrieving the aforesaid set of documents based on the search query.

Throughout the present disclosure, the term “search query” relates to a query which is used for searching information stored a database. In other words, search query is used as a basis for retrieving the set of documents. Further, the term query refers to a question about which information is required and/or about which more clarity about information known previously is required by a user. In an example, search query is ‘drugs for lung cancer’. In another example, search query is ‘heart attack’.

In an embodiment, the search query is in form of text. The search query in form of text is a single word or a combination of words. In an example, search query in form of single word text is ‘cancer’. In an example, search query in form of combination of words text is ‘lung cancer’ based on which the set of documents having stored information related to lung cancer are retrieved.

In an embodiment, the search query is in form of image wherein the image comprises text therein. The text in the image is further extracted and thereby the extracted text is used as the basis on which the set of documents having stored information are retrieved. In an example, the search query is an image comprising a text such as ‘lung cancer symptoms’. Therefore, the text ‘lung cancer symptoms’ is used as search query by the system based on which the set of documents having stored information related to symptoms of lung cancer are retrieved.

Throughout the present disclosure, the term “set of documents” relates to documents which have information related to search query stored in them. The information stored in the set of documents may be in form of text data, tabular data, graphical data, image data, video data, audio data or any combination thereof. In an example, the set of documents may be portable document format (PDF), web page, Joint Photographic Experts Group. (JPEG) file, MS-WORD file, and/or a combination thereof. In an embodiment, the set of documents can have documents in form of web accessible links, from where the information is retrieved based upon the search query. Thus, documents can be in any suitable file formats depending upon the type of data that is stored therein. As an example, the set of documents could comprise a single document having one or more of: a written text, one or more tables, one or more graphs, or a set of images. As another example, the set of documents could comprise multiple documents having different types of data, for example, such as a written text, one or more tables, one or more graphs, a set of images, one or more videos, or one or more audio clips.

The system comprises the client device configured to receive the search query and provide the set of documents.

Throughout the present disclosure, the term “server arrangement” refers to an arrangement of one or more servers that includes one or more processors configured to perform various operations, for example, as mentioned earlier. Optionally, the server arrangement includes any arrangement of physical or virtual computational entities capable of performing the various operations. The term “one or more processors” may refer to one or more individual processors, processing devices and various elements associated with a processing device that may be shared by other processing devices. Additionally, the one or more individual processors, processing devices and elements are arranged in various architectures for responding to and processing the instructions that drive the aforesaid system.

Moreover, it will be appreciated that the server arrangement can be implemented by way of a single hardware server. The server arrangement can alternatively be implemented by way of a plurality of hardware servers operating in a parallel or distributed architecture. As an example, the server arrangement may include components such as memory, a processor, a network adapter, and the like, to store and process information pertaining to the document and to communicate the processed information to other computing components, for example, such as a client device.

Throughout the present disclosure, the term “server” generally refers to a device executing an application, program, or process in a client/server relationship that responds to requests for information or services by another application, program, process, or device (namely, a client) on a data communication network. Optionally, a given server is implemented by way of a device executing a computer program that provides various services (for example, such as a database service) to other devices, modules, or apparatus.

The system comprises the client device configured to receive the search query and provide the set of documents. The term “client device” generally refers to a device executing an application, program, or process in a client/server relationship that requests information or services from another application, program, process, or device (namely, a server) on a data communication network. Importantly, the terms “client” and “server” are relative, as an application may be a client to one application but a server to another application. The client device is a combination of software and hardware components. The client device allows the user (such as an individual and/or organization) to enter the search query. In an example, the client device can be implemented using but not limited to, mobile phones, smart telephones, Mobile Internet Devices (MIDs), tablet computers, Ultra-Mobile Personal Computers (UMPCs), phablet computers, Personal Digital Assistants (PDAs), web pads, Personal Computers (PCs), handheld PCs, laptop computers, desktop computers, large-sized touch screens with embedded PCs, a server, and Network-Attached Storage (NAS) devices. The user enters the search query corresponding to the information required by the user. In an example, the user enters a search query such as ‘heart attack’ on a personal computer to obtain information related to heart attack required by the user. Furthermore, the client device comprises a memory, a display, a processor and so forth.

In an embodiment, the user enters the search query on client device in form of a text or an image or combination of both. In an example, the user enters a search query on a mobile phone, in form of a text such as ‘heart attack symptoms’ corresponding to the information related to conditions of a patient that can cause heart attack, required by the user. In another embodiment, the user enters the search query in form of a text in different languages. In an example, the user enters a search query in form of text in English language, French language, Hindi language, and the like. In an embodiment, the system converts the language in which search query is entered into a standard language, wherein standard language is the language in which the information is stored in all the documents such that information which are not in standard language are converted into standard language by the system. In an example, the system may have all information stored in a standard language such as English language thereby the information which is in different language such as German language, is then converted into English language. In such a case, the search query entered by the user in any language is converted into English language.

The system comprises the lexical database comprising the plurality of concepts, and conceptual synonyms of each of the plurality of concepts. Throughout the present disclosure, the term “lexical database” relates to a repository for storing the plurality of concepts and the conceptual synonyms corresponding to each of the plurality of concepts. Throughout the present disclosure, the term “plurality of concepts” relates to concepts (namely topics, subject areas) relating to a specific domain (namely, subject matter, field of study). Additionally, a given concept and corresponding conceptual synonyms of the given concept have common characteristics associated with them. Specifically, the characteristics relate to a meaning, properties, contextual usage and so forth. Therefore, each concept and its corresponding conceptual synonyms have a common meaning, properties, and contextual usage. It will be appreciated that conceptual synonyms of a given concept are also concepts in the domain and thus, a concept and its corresponding conceptual synonyms may merely be a collection of concepts having common characteristics associated therewith. In an example, a collection of concepts has concepts such as ‘lung cancer’, ‘lung carcinoma’, ‘lung neoplasm’, and ‘lung tumor’, wherein ‘lung cancer’, ‘lung carcinoma’, ‘lung neoplasm’, and ‘lung tumor’ are conceptual synonyms of each other. In such an example, all the concepts ‘lung cancer’, ‘lung carcinoma’, ‘lung neoplasm’, and ‘lung tumor’ have similar conceptual meaning—lung cancer. Furthermore, in such example, in a first case ‘lung carcinoma’, ‘lung neoplasm’, and ‘lung tumor’ are conceptual synonyms of ‘lung cancer’. In a second case, ‘lung cancer’, ‘lung neoplasm’, and ‘lung tumor’ are conceptual synonyms of ‘lung carcinoma’. In a third case, ‘lung carcinoma’, ‘lung cancer’, and ‘lung tumor’ are conceptual synonyms of ‘lung neoplasm’. In a fourth case, ‘lung carcinoma’, ‘lung neoplasm’, and ‘lung cancer’ are conceptual synonyms of ‘lung tumor’.

Optionally, each of the plurality of concepts in the lexical database are tagged with a predefined class. Throughout the present disclosure, the term “predefined class” refers to a category (namely, classification) of concepts in the specific domain. It will be appreciated that the ontological databank comprises multiple predefined classes therein. Specifically, the plurality of concepts are tagged with one of the multiple predefined classes such that each of the concepts is tagged with exactly one predefined class. Notably, concepts in a given predefined class may have a common property therebetween. In an example, a plurality of concepts such as ‘heart attack’, ‘cardiac arrest’, ‘coronary thrombosis’, ‘coronary occlusion’ is tagged to a predefined class ‘heart diseases’. In another example, a plurality of concepts comprising concepts ‘lung cancer’, ‘lung carcinoma’, ‘lung neoplasm’, and ‘lung tumor’ is tagged to a predefined class ‘lung disease’.

The system comprises the structured database communicably coupled to the lexical database. Throughout the present disclosure, the term “structured database” relates to a database repository comprising the plurality of documents in an organized form which have information stored in them. The plurality of documents are organized by way of indexing, wherein each of the plurality of document is indexed based on the information therein. Such indexing of the plurality of documents enables efficient retrieval of relevant documents. Furthermore, indexing of the plurality of documents is discussed herein later. The structured database is communicably coupled to the lexical database via wired networks, wireless networks, or a combination thereof. Examples of such networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, fifth generation (5G) telecommunication networks and Worldwide Interoperability for Microwave Access (WiMAX) networks.

The structured database is developed by extracting the plurality of documents from existing data sources. Throughout the present disclosure, the term “existing data sources” relates to a repository where the data is stored in a digital form that can be extracted by the system for the structured database for further computational process. Furthermore, the existing data sources may refer to organized or unorganized bodies of digital information regardless of manner in which data is represented therein. Optionally, the existing data sources are structured and/or unstructured. Optionally, the existing data sources may be hardware, software, firmware and/or any combination thereof. For example, the existing data sources may be in form of tables, maps, grids, packets, datagrams, files, documents, lists or in any other form. The existing data sources include any data storage software and systems, such as, for example, a relational database like IBM, DB2, Oracle 9 and so forth. Moreover, the existing data sources may include the data in form of text, audio, video, image, and/or a combination thereof. In an embodiment, one data source can be providing the plurality of documents related to one specific field (namely, subject area, domain and so forth). In another embodiment, one data source can be providing the plurality of documents related to more than one specific field. In an example, one data source can be providing the plurality of documents related to only life science field. In another example, one data source can be providing the plurality of documents related to life science field, electronics field, physics field, and computers field. Furthermore, retrieving data spread across various centralized and/or distributed existing data sources is performed using existing data extraction techniques.

Throughout the present disclosure, the term “plurality of documents” relates the documents stored in the structured database. The information stored in the plurality of documents may be in form of text data, tabular data, graphical data, image data, video data, audio data or any combination thereof. In an example, the plurality of documents may be portable document format (PDF), web page, Joint Photographic Experts Group. (JPEG) file, MS-WORD file, and/or a combination thereof. In an embodiment, the plurality of documents can have documents in form of web accessible links, from where the information is retrieved. Thus, documents can be in any suitable file formats depending upon the type of data that is stored therein.

The structured database is developed by analyzing each of the plurality of documents to determine at least one concept corresponding to each of the plurality of documents. Specifically, each of the plurality of documents is analyzed to determine at least one concept, from the plurality of concepts in the lexical database, corresponding to each of the plurality of documents. In an embodiment, the at least one concept is mapped with the information stored in each of the plurality of document. Specifically, information in a given document is compared with the lexical database to determine at least one concept corresponding to the given document. In an example, each of the word in a given document is compared with the plurality of concepts and the conceptual synonyms in the lexical database to determine at least one concept corresponding to the given document. In another example, a context of a given document is analyzed to identify at least one concept corresponding to the given document.

The structured database is developed by indexing the plurality of documents using the lexical database, wherein the given document is indexed based on the at least one concept corresponding to the given document, and conceptual synonyms of the at least one concept corresponding to the given document. Throughout the present disclosure, the term “indexing” relates to listing the plurality of documents stored in the structured database such that at least one concept and conceptual synonyms corresponding to each of the plurality of documents is listed along with the plurality of documents. The indexing allows optimizing the plurality of documents in the structured database according to the at least one concept and the conceptual synonyms. In an example, a plurality of documents comprises document1, document2, document3, document4, and document5. In such an example, document1 has corresponding concepts ‘lung cancer’, and ‘heart attack’, and conceptual synonyms ‘lung carcinoma’, and ‘lung tumor’; document2 has corresponding concepts ‘brain tumor’; document3 has corresponding concepts ‘diabetes’, and ‘tuberculosis’, and conceptual synonyms ‘phthisic’; document4 has corresponding concepts ‘arthritis’; document5 has corresponding concepts ‘asthma’, and ‘dementia’, and conceptual synonyms ‘bronchospasm’. Further, in such an example, the structured database is developed by listing the plurality of documents corresponding to at least one concept and conceptual synonyms in a tabular representation wherein documents are listed in one column, at least one concepts corresponding to the documents are listed in second column, and conceptual synonyms are listed in third column.

In an embodiment, the plurality of documents may correspond to only the at least one concept and not the conceptual synonyms of the at least one concept. Thereby, the plurality of documents indexed into list, the list may comprise only the at least one concept and not the conceptual synonyms. In such an embodiment, it is to be understood, that the plurality of documents correspond to conceptual synonyms of the at least one concept along with the at least one concept. In an example, a plurality of documents comprises document1, document2, document3, document4, and document5. In such an example, document1 has corresponding concepts ‘lung cancer’, and ‘heart attack’; document2 has corresponding concepts ‘brain tumor’; document3 has corresponding concepts ‘diabetes’, and ‘tuberculosis’; document4 has corresponding concepts ‘arthritis’; document5 has corresponding concepts ‘asthma’, and ‘dementia’. Further, in such an example, the structured database is developed by listing the plurality of documents corresponding to at least one concept in a tabular representation wherein documents are listed in one column, at least one concepts corresponding to the documents are listed in second column. In such an example, the plurality of documents also correspond to the conceptual synonyms such as document1 correspond to conceptual synonyms ‘cardiac arrest’, ‘lung carcinoma’, and ‘lung tumor’; document2 correspond to conceptual synonyms ‘brain cancer’; document3 correspond to conceptual synonyms ‘phthisic’; document4 correspond to conceptual synonyms ‘fibromyalgia’, ‘lupus’; document5 correspond to conceptual synonyms ‘bronchospasm’.

The system comprises the server arrangement communicably coupled to the client device, the lexical database, and the structured database. The server arrangement is configured to receive the search query, from the client device. The server arrangement receives the search query entered by the user on the client device in form of an input.

The server arrangement is configured to segment the search query into one or more query segments. The search query includes one or more query segments (namely, fragments, elements, phrases and so forth) and contextual (namely, conceptual, semantic and so forth) association thereof. Moreover, the query segments are parts of search query having a significant contextual meaning. Furthermore, the processing module is operable to receive a user query having one or more query segments. Moreover, the processing module is operable to analyse the user query based on context of elements included therein. Additionally, the user query is in text format. Optionally, the user query may be provided using a command prompt (cmd), user interface (UI) and so forth. In an example, a search query such as ‘brain tumor symptoms’ is segmented into ‘brain tumor’ and ‘symptoms’. Each query segment has characteristics and a definitive meaning associated with it. The characteristic of the query segment comprises a meaning of the query segment, properties of the query segment and outcomes related to query segment.

Optionally, n-gram model is used for the comparison of the one or more query segments with the plurality of concepts, and the conceptual synonyms of each of the plurality of concepts stored in the lexical database. It will be appreciated that the n-gram model relates to a contiguous sequence of ‘n’ items from a given one or more query segment, wherein ‘n’ represents number of query segments within each of the search query. In this regard, the search query having one segment is referred as unigram or one-gram, the sentence having two segments are referred as bigram or two-gram, the sentence having three segments are referred as trigram or three-gram. Similarly, based on the number of the segments, the one or more query segments is referred as ‘four-gram’, ‘five-gram’, and so on. In an example, the plurality of segments generated for a search query such as ‘top drugs for tumor’ may be ‘top drugs for tumor’, ‘top drugs for’, ‘drugs for tumor’, ‘top drugs’, ‘drugs for’, ‘for tumor’, ‘top’, ‘drugs’, ‘for’ and ‘tumor’. In such an example, the plurality of segments ‘top drugs for tumor’ is the four-gram. Similarly, the plurality of segments ‘top drugs for’, and ‘drugs for tumor’ could be the trigram or three-gram, the plurality of segments ‘top drugs’, ‘drugs for’, and ‘for tumor’ could be bigram or two-gram and the plurality of segments ‘top’, ‘drugs’, ‘for’ and ‘tumor’ could be unigram or one-gram.

The server arrangement is configured to analyze the one or more query segments to determine one or more concepts corresponding to the one or more query segments. The one or more query segments is analyzed to determine one or more concepts corresponding to the one or more query segments by mapping each of the one or more query segments with the each of the concepts in the plurality of concepts stored in the lexical database. The mapping is performed by comparing the characteristics of the each of the one or more query segments with the characteristics of each of the concepts in the plurality of concepts in the lexical database. The one or more concepts having characteristics similar to the characteristics are thereby selected as one or more concepts corresponding to the one or more query segments. The similar characteristics comprise having similar meaning, similar properties and similar outcomes.

In an example, a search query such as ‘lung cancer symptoms’ and plurality of concepts such as ‘lung carcinoma’, ‘heart attack’, ‘brain tumor’, ‘asthma’, ‘traits’, ‘effect’. In such an example, the search query is segmented into query segment ‘lung cancer’ and ‘symptoms’. In such an example, each of query segments ‘lung cancer’ and ‘symptoms’ are mapped with each of plurality of concepts ‘lung carcinoma’, ‘heart attack’, ‘brain tumor’, ‘asthma’, ‘traits’, ‘effect’. In such an example, the concept ‘lung carcinoma’ has characteristics similar to the characteristics of query segment ‘lung cancer’ and the concept ‘traits’ has characteristics similar to the characteristics of query segment ‘symptoms’. Therefore, ‘lung carcinoma’ and ‘traits’ are the concepts corresponding to query segments ‘lung cancer’ and ‘symptoms’.

Optionally, analyzing the one or more query segments to determine one or more concepts corresponding thereto comprises identifying a predefined class associated with the one or more query segments. The predefined class associated with a query segment is identified to retrieve the set of documents related to a similar context as the context of the query segment. In an example, a query segment analyzed to be relating to a context such as ‘lung diseases’ has the predefined class identified as ‘lung disease’ instead of ‘drug for lung disease’.

In an embodiment, a predefined class may be associated with more than one plurality of concepts. The identification of the predefined class associated with one or more query segment thereby allows ease in analysis of the one or more query segments to determine one or more concepts corresponding to the one or more query segments.

Optionally, analyzing the one or more query segments comprises filtering noise from the one or more query segments prior to determining one or more concepts corresponding to the one or more query segments. Throughout the present disclosure, the term “noise” relates to a deviation in the one or more query segment such that the one or more concepts cannot be determined based on the one or more query segment. The noise in the one or more query segment may result in inappropriate set of documents to be retrieved on the client device.

In an embodiment, the deviation in the one or more query segment refers to the query segments not corresponding to the one or more concepts. In an example, a search query such as ‘what is brain tumor’ segmented into query segments ‘what’, ‘is’, ‘brain tumor’. In such an example, the query segments ‘what’ and ‘is’ do not correspond to the one or more concepts in the lexical database. In such an example, the query segment ‘what’ and ‘is’ are thereby filtered and the set of documents comprising only ‘brain tumor’ are retrieved.

In another embodiment, the deviation in the one or more query segment refers to misspelling of the one or more query segments. In an example, a search query such as ‘lucg cancre’ segmented into query segment ‘lucg cancre’. In such an example, the query segment ‘lucg cancre’ do not correspond to the one or more concepts in the lexical database. In such an example, the noise in the query segment ‘lucg cancre’ is removed and thereby the query segment is converted to ‘lung cancer’.

In yet another embodiment, Boolean operators such as ‘AND’, ‘OR’, ‘NOT’ used in the search query are identified. The identification of the Boolean operator allows in obtaining a relation between the query segments on which the Boolean operator is applied in the search query. The Boolean operators allows in broadening or narrowing a scope of the search query. The Boolean operator ‘AND’ makes the scope of the search query narrow, the retrieved documents will thereby have both the query segment on which the Boolean operator ‘AND’ is applied. In an example, a search query such as ‘lung cancer and brain tumor’ have query segments ‘lung cancer’ and ‘brain tumor’ and Boolean operator ‘AND’. In such an example, each of the set of documents retrieved have both lung cancer and brain tumor present in them. In another example, a structured database having document1, document2, document3 and document4 comprises concept ‘heart attack’ in document1, ‘brain tumor’ in document2 and ‘brain tumor’, and ‘heart attack’ in document3. In such an example, the search query is ‘brain tumor and heart attack’ and has query segment ‘brain tumor’ and ‘heart attack’ and Boolean operator ‘AND’. In such an example, only document3 comprising both ‘brain tumor’ and ‘heart attack’ is retrieved. The Boolean operator ‘OR’ makes the scope of the search query broader, the retrieved documents will thereby have the query segment on which the Boolean operator ‘OR’ is applied. In an example, a search query such as ‘lung cancer or brain tumor’ have query segments ‘lung cancer’ and ‘brain tumor’ and Boolean operator ‘OR’. In such an example, each of the set of documents retrieved have only lung cancer, only brain tumor and both brain tumor and lung cancer, present in them. In another example, a structured database having document1, document2, and document3 comprises concept ‘heart attack’ in document1, ‘brain tumor’ in document2 and ‘brain tumor’, and ‘heart attack’ in document3. In such an example, the search query is ‘brain tumor or heart attack’ and has query segment ‘brain tumor’ and ‘heart attack’ and Boolean operator ‘OR’. In such an example, document1, document2 and document3 are retrieved. The Boolean operators ‘NOT’ makes the scope of the search query either broader or narrower, the query segment after the Boolean operator ‘NOT’ is excluded from the query segment before the Boolean operator ‘NOT’, the retrieved documents will thereby have the query segment on which the Boolean operator ‘NOT’ is applied. In an example, a search query such as ‘lung cancer NOT brain tumor’ have query segments ‘lung cancer’ and ‘brain tumor’ and Boolean operator ‘NOT’. In such an example, each of the set of documents retrieved have only lung cancer and not both brain tumor and lung cancer, present in them. In another example, a structured database having document1, document2, and document3 comprises concept ‘heart attack’ in document1, ‘brain tumor’ in document2 and ‘brain tumor’, and ‘heart attack’ in document3. In such an example, the search query is ‘brain tumor not heart attack’ and has query segment ‘brain tumor’ and ‘heart attack’ and Boolean operator ‘NOT’. In such an example, document1, is only retrieved.

The server arrangement is configured to identify, using the lexical database, conceptual synonyms of each of the one or more concepts corresponding to the one or more query segments. Specifically, the conceptual synonyms of the at least one concept are retrieved from the lexical database and associated with the at least one concept. In an example, the concepts ‘lung carcinoma’ and ‘traits’ correspond to query segments ‘lung cancer’ and ‘symptoms’. In such an example, concept ‘lung carcinoma’ has conceptual synonyms ‘lung neoplasm’, and ‘lung tumor’ in the lexical database, and concept ‘traits’ has conceptual synonyms ‘characteristics’, and ‘attributes’. In such an example, the conceptual synonyms ‘lung neoplasm’, ‘lung tumor’, ‘characteristics’, and ‘attributes’ are identified as conceptual synonyms of concepts ‘lung carcinoma’ and ‘traits’ corresponding to query segments ‘lung cancer’ and ‘symptoms’.

The server arrangement is configured to retrieve the set of documents from the structured database based on the one or more concepts corresponding to the one or more query segments and conceptual synonyms of each of the one or more concepts corresponding to the one or more query segments. As mentioned previously, the set of documents in the structured database are indexed based on the at least one concept corresponding to the given document, and conceptual synonyms of the at least one concept corresponding to the given document. Further, based on the indexing of the set of documents in the structured database, the set of documents are retrieved based on concepts and conceptual synonyms of concepts corresponding to query segments, on the client device.

In an embodiment, one or more concepts and conceptual synonyms in lexical database correspond to information stored in form of documents in the structured database. The information stored in documents is positioned at different locations within the document. In an embodiment, the lexical database comprising the one or more concepts and conceptual synonyms also comprises location of the information corresponding to the one or more concepts and conceptual synonyms, stored with the one or more concepts and conceptual synonyms. The location of the information corresponding to the one or more concepts and conceptual synonyms allows in easy retrieval of the set of documents from the structural database.

In an example, a structured database comprises plurality of documents such as document1, document2, and document3. The plurality of documents in the structured database is indexed in form of list comprising the documents and the corresponding concepts and conceptual synonyms such that, document1 comprises concept ‘lung cancer’ and conceptual synonym ‘lung neoplasm’, document2 comprises concept ‘cardiac arrest’ and conceptual synonym ‘heart attack’, document3 comprises concept ‘asthma’ and ‘lung tumor’. In such an example, search query is ‘lung tumor’ and thereby the query segment is ‘lung tumor’. In such an example, the query segment ‘lung tumor’ corresponds to concept ‘lung cancer’ and conceptual synonym ‘lung neoplasm’. Therefore, the document1 and document3 are retrieved from the structured database.

Optionally, the server arrangement is configured to provide a summarized view of the one or more concepts corresponding to the one or more query segments on the client device. Throughout the present disclosure, the term “summarized view” relates to a compressed view of the one or more concepts corresponding to the one or more query segments, on the client device, such that via the compressed view the user can filter the set of documents to retrieve only a reduced set of documents based on selected one or more concepts. The selected one or more concepts refers to the concepts corresponding to the one or more query segment which are selected by the user on the client device to reduce the set of documents retrieved on the client device.

In an example, a client device such as mobile phone provides a summarized view in form of a list comprising all the concepts such as ‘lung cancer’, ‘lung carcinoma’, ‘lung neoplasm’, and ‘lung tumor’ corresponding to the query segment ‘lung cancer’. In such an example, document1, document2 and document4 comprises lung cancer; document3, document5, document7 comprises lung carcinoma; document6, document8 comprises lung neoplasm; document9 comprises lung tumor. In such an example, a user selects the concepts ‘lung cancer’, and ‘lung carcinoma’. In such an example, based on the selection of the concepts a set of documents such as document1, document2, document3, document4, document5, and document6 comprising ‘lung cancer’, and ‘lung carcinoma’ are retrieved.

The present disclosure also relates to the method as described above. Various embodiments and variants disclosed above apply mutatis mutandis to the method.

Optionally, the method further comprises providing a summarized view of the one or more concepts corresponding to the one or more query segments on the client device.

Optionally, in the method, each of the plurality of concepts in the lexical database are tagged with a predefined class.

Optionally, in the method, analyzing the one or more query segments to determine one or more concepts corresponding thereto comprises identifying a predefined class associated with the one or more query segments.

Optionally, in the method, analyzing the one or more query segments comprises filtering noise from the one or more query segments prior to determining one or more concepts corresponding to the one or more query segments.

### DETAILED DESCRIPTION OF THE DRAWINGS

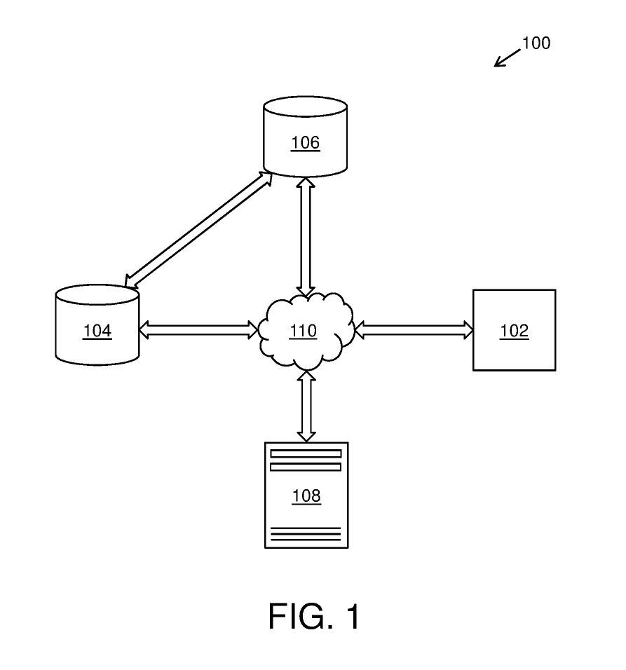

Referring to FIG. 1, illustrated is a network environment of a system 100 for optimizing a search query to retrieve a set of documents, in accordance with an embodiment of the present disclosure. The system 100 comprises a client device 102, a lexical database 104, a structured database 106, and a server arrangement 108. The structured database 106 is communicably coupled to the lexical database 104. The server arrangement 108 is communicably coupled to the client device 102, the lexical database 104 and the structured database 106 via a network 110. The client device 102 is configured to receive the search query and provide the set of documents. The lexical database 104 comprises a plurality of concepts, and conceptual synonyms of each of the plurality of concepts.

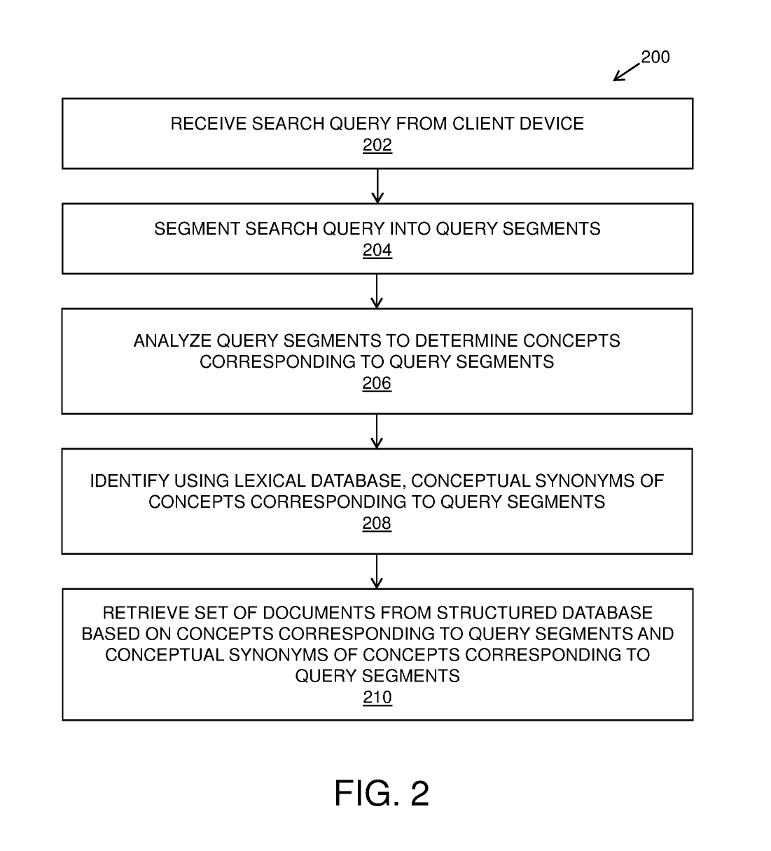

Referring to FIG. 2, illustrated is a method 200 of optimizing a search query to retrieve a set of documents, in accordance with an embodiment of the present disclosure. At step 202, the search query is received from the client device. At step 204, the search query is segmented into one or more query segments. At step 206, the one or more query segments is analyzed to determine one or more concepts corresponding to the one or more query segments. At step 208, conceptual synonyms of each of the one or more concepts corresponding to the one or more query segments are identified using the lexical database. At step 210, the set of documents from the structured database is retrieved based on the one or more concepts corresponding to the one or more query segments and conceptual synonyms of each of the one or more concepts corresponding to the one or more query segments.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A system for optimizing a search query to retrieve a set of documents, the system comprising:
a client device configured to receive the search query and provide the set of documents;
a lexical database comprising a plurality of concepts, and conceptual synonyms of each of the plurality of concepts;
a structured database communicably coupled to the lexical database, wherein the structured database is developed by:
extracting a plurality of documents from existing data sources;
analyzing each of the plurality of documents to determine at least one concept corresponding to each of the plurality of documents; and
indexing the plurality of documents using the lexical database, wherein a given document is indexed based on the at least one concept corresponding to the given document, and conceptual synonyms of the at least one concept corresponding to the given document; and
a server arrangement communicably coupled to the client device, the lexical database and the structured database, wherein the server arrangement is configured to:
receive the search query, from the client device;
segment the search query into one or more query segments;
analyze the one or more query segments to determine one or more concepts corresponding to the one or more query segments;
identify, using the lexical database, conceptual synonyms of each of the one or more concepts corresponding to the one or more query segments; and
retrieve the set of documents from the structured database based on the one or more concepts corresponding to the one or more query segments and conceptual synonyms of each of the one or more concepts corresponding to the one or more query segments.

2. The system of claim 1, wherein the server arrangement is configured to provide a summarized view of the one or more concepts corresponding to the one or more query segments on the client device.

3. The system of claim 1, wherein each of the plurality of concepts in the lexical database are tagged with a predefined class.

4. The system of claim 3, wherein analyzing the one or more query segments to determine one or more concepts corresponding thereto comprises identifying a predefined class associated with the one or more query segments.

5. The system of claim 1, wherein analyzing the one or more query segments comprises filtering noise from the one or more query segments prior to determining one or more concepts corresponding to the one or more query segments.

6. A method of optimizing a search query to retrieve a set of documents, the method is implemented via a system comprising:
a client device configured to receive the search query and provide the set of documents;
a lexical database comprising a plurality of concepts, and conceptual synonyms of each of the plurality of concepts;
a structured database communicably coupled to the lexical database, wherein the structured database is developed by:
extracting a plurality of documents from existing data sources;
analyzing each of the plurality of documents to determine at least one concept corresponding to each of the plurality of documents; and
indexing the plurality of documents using the lexical database, wherein a given document is indexed based on the at least one concept corresponding to the given document, and conceptual synonyms of the at least one concept corresponding to the given document; and
a server arrangement communicably coupled to the client device, the lexical database and the structured database, wherein the method comprises:
receiving the search query, from the client device;
segmenting the search query into one or more query segments;
analyzing the one or more query segments to determine one or more concepts corresponding to the one or more query segments;
identifying, using the lexical database, conceptual synonyms of each of the one or more concepts corresponding to the one or more query segments; and
retrieving the set of documents from the structured database based on the one or more concepts corresponding to the one or more query segments and conceptual synonyms of each of the one or more concepts corresponding to the one or more query segments.

7. The method of claim 6, wherein the method comprises providing a summarized view of the one or more concepts corresponding to the one or more query segments on the client device.

8. The method of claim 6, wherein each of the plurality of concepts in the lexical database are tagged with a predefined class.

9. The method of claim 8, wherein analyzing the one or more query segments to determine one or more concepts corresponding thereto comprises identifying a predefined class associated with the one or more query segments.

10. The method of claim 6, wherein analyzing the one or more query segments comprises filtering noise from the one or more query segments prior to determining one or more concepts corresponding to the one or more query segments.
